(19) United States
(12) Patent Application Publication
(10) Pub. No.: US 2023/0012012 A1
(43) Pub. Date: Jan. 12, 2023

(54) A PUMP ADAPTED TO EXERT A COMPRESSION ACTION ON A FLUID AND MOTOR ACTUATED BY A CORRESPONDING PROPULSION FLUID

(71) Applicant: FERRONI TRANSMISSION S.R.L., Castelnovo di Sotto (RE) (IT)

(72) Inventor: Bruno FERRONI, Castelnova di Sotto (RE) (IT)

(21) Appl. No.: 17/782,450

(22) PCT Filed: Dec. 5, 2019
(86) PCT No.: PCT/IB2019/060482

§ 371 Date: Jun. 3, 2022

(51) Int. Cl. F04B 1/0426; F04B 1/07; F03C 1/04

(52) U.S. Cl. CPC F04B 1/0426; F04B 1/07; F03C 1/0419

(57) ABSTRACT

A pump for exerting a compression action on a fluid, includes a casing for rotatably supporting a shaft having an axis; and an actuating device for actuating the fluid, including a reciprocating device movable in an axial direction. A connection device includes a driving device having a circumferential surface eccentrically extending from the axis and which is rotatable together with the shaft. A device for transmitting a driving motion of the eccentric surface to the actuation device includes a body suitable to convert the rotary motion of the eccentric driving surface into said reciprocating axial motion for the actuating device. A motor includes a drive shaft rotated by a fluid device. The fluid device including reciprocatingly movable thrust devices and a transformation device for transforming movement of the thrust devices, into a rotary motion of the drive shaft.

### FIELD OF APPLICATION OF THE PRESENT INVENTION

The present invention relates to a pump suitable to exert a compression action on a fluid, in particular on a liquid, especially said liquid being in the form of water or hydraulic oil.

The present invention also relates to a motor, actuated by a corresponding propulsion fluid, in particular in the form of pressurised hydraulic oil, or in the form of a fuel fluid generating, through a corresponding explosion, a corresponding expansion force.

### STATE OF THE ART

Pumps which are suitable to exert a compression action on a liquid are known. Said prior art pumps comprise a casing for the rotatable support of a corresponding rotary shaft, the shaft having a respective rotation axis, means for actuating said fluid, which are in the form of means reciprocatingly movable according to a respective axial direction, in particular, perpendicular or transversal to the rotation axis of said shaft, between a position which is retracted or approached to said rotation axis, and a position which is extended moved away from the rotation axis.

Furthermore, provided for in said prior art pumps are means for actuating the fluid comprising a corresponding crank which is rotatably associated with said rotary drive shaft, and which is connected to a corresponding connecting rod, in turn, connected to the respective piston for actuating the liquid.

However, such prior art axial pumps have the drawback lying in that they are excessively bulky and they also require, for the assembly thereof, the use of excessive working times or the use of an excessive number of components.

Furthermore, in the industry, there also arises the need to have a pump that is robust and resistant to breakage and to wear.

In addition, in the industry, there arises the need to have a pump that is structurally simple and cost-effective.

Additionally, in the industry, there arises the need to have a pump which is particularly versatile and/or flexible in use.

Motors actuated by a corresponding propulsion fluid, in particular in the form of pressurised hydraulic oil, or in the form of a fuel fluid generating, through a corresponding explosion, a corresponding expansion force, are also known.

Said prior art motors generally comprise a casing for the rotatable support of a corresponding drive shaft, having a respective rotation axis, and means for the rotary actuation of said drive shaft upon a thrust of said propulsion fluid, the rotary actuation means comprising thrust pistons reciprocatingly movable between a position which is retracted or approached to said rotation axis, and a position which is extended or moved away from the axis of rotation.

Furthermore. In prior art motors, provided for are corresponding means for transforming the movement of said thrust means, or respective piston into a rotary motion of said drive shaft, preferably in the form of a corresponding connecting rod and crank.

A problem experienced in the manufacture of these prior art motors concerns the excessive quantity which said motors have, which does not make them easily usable in certain situations of use, where small dimensions and/or weight are desired.

Furthermore, in the industry, there also arises the need to have a motor that is robust and resistant to breakage and to wear.

### SUMMARY OF THE INVENTION

In any case, the present invention aims at providing a new and/or alternative solution to the solutions known up to now and in particular it aims at overcoming one or more of the drawbacks or problems referred to above, and/or at satisfying one or more requirements experienced in the art, and in particular evincible from the information provided above.

Thus, herein provided is a pump suitable to exert a compression action on a fluid, in particular on a liquid, especially said liquid being in the form of water or hydraulic oil; the pump comprising a casing for the rotatable support of a corresponding shaft having a respective rotation axis, means for the actuation of said fluid which are in the form of means reciprocatingly movable according to a respective axial direction, in particular perpendicular or transversal to the rotation axis of said shaft, between a position which is retracted or approached to said rotation axis, and a position which is extended or moved away from the rotation axis; said fluid actuation means comprising at least one respective piston which is reciprocatingly moveable according to said axial direction; and provided for being corresponding means for the operative connection between said fluid actuation means, or respective piston; characterised in that said operative connection means comprise respective driving means, which comprise at least one circumferential surface which is eccentrically extended with respect to said rotation axis and which is rotatable together, in particular being integrally joined, with the rotary shaft, and motion transmission means for the driving of said eccentric surface to said fluid actuation means, or respective piston, the transmission means comprising a respective body which is suitable to convert the rotary motion of said eccentric driving surface into said reciprocating axial displacement for said fluid actuation means, or respective piston.

In this manner, it is possible to provide an axial pump which has conveniently small dimensions.

Further provided for is a motor, actuated by a corresponding propulsion fluid, in particular in the form of a pressurised hydraulic oil, i.e., in the form of a fuel fluid generating, through a corresponding explosion, a corresponding expansion force; comprising a casing for the rotatable support of a corresponding drive shaft, having a respective rotation axis, and means for driving said drive shaft in rotation upon a thrust of said propulsion fluid, said means for driving in rotation comprising thrust means reciprocatingly movable between a position which is retracted or approached to said rotation axis, and a position which is extended or moved away from the rotation axis; in particular said thrust means comprising at least one respective piston which is reciprocatingly movable between said respectively extended and retracted first and second positions; provided for being corresponding means for the transformation of the motion of said thrust means, or respective piston, into a rotary motion of said drive shaft; characterised in that said transformation means comprise a respective movable translating body, according to the respective motion direction of said thrust means, or respective piston, and a circumferential surface, which is eccentrically extended with respect to said rotation axis and integrally joined in rotation with the drive shaft, said eccentric circumferential surface being driven in rotation by the corresponding movement of said translating body so as to drive the drive shaft in rotation.

In this manner, a motor can be obtained being conveniently small in size.

### BRIEF DESCRIPTION OF THE DRAWINGS

This and other innovative aspects, or specific advantageous embodiments, are, however, set forth in the claims outlined below, whose technical characteristics can be found in the following detailed description, illustrating preferred and advantageous embodiments, which shall however be considered as merely exemplifying and non-limiting examples of the invention; said description being outlined with reference to the attached drawings, wherein:

FIG. 1 illustrates a longitudinal sectional schematic view of a first preferred embodiment of the pump according to the present invention;

FIG. 2 illustrates a longitudinal and vertical sectional schematic view of a detail of a variant of the first preferred embodiment of the pump according to the present invention;

FIG. 3 illustrates a cross-sectional schematic view of a detail of a variant of the first preferred embodiment of the pump according to the present invention;

FIG. 4 illustrates a longitudinal and horizontal sectional schematic view of the detail of the variant of the first preferred embodiment of the pump according to the present invention;

FIG. 5 illustrates a longitudinal sectional schematic view of second preferred embodiment of the pump according to the present invention;

FIG. 6 illustrates a cross-sectional schematic view of a first preferred embodiment of the motor according to the present invention;

FIG. 7 illustrates a longitudinal sectional schematic view of the first preferred embodiment of the motor according to the present invention;

FIG. 8 illustrates a longitudinal sectional schematic view of a second preferred embodiment of the motor according to the present invention;

FIG. 9 illustrates a longitudinal and vertical sectional schematic view of a detail of a variant of the first preferred embodiment of the motor according to the present invention;

FIG. 10 illustrates a cross-sectional schematic view of the detail of the variant of the first preferred embodiment of the motor according to the present invention;

FIG. 11 illustrates a longitudinal and horizontal sectional schematic view of a detail of a variant of the first preferred embodiment of the motor according to the present invention;

FIG. 12 illustrates a longitudinal sectional schematic view of a second preferred embodiment of the motor according to the present invention.

### DETAILED DESCRIPTION OF PREFERRED EMBODIMENTS OF THE INVENTION

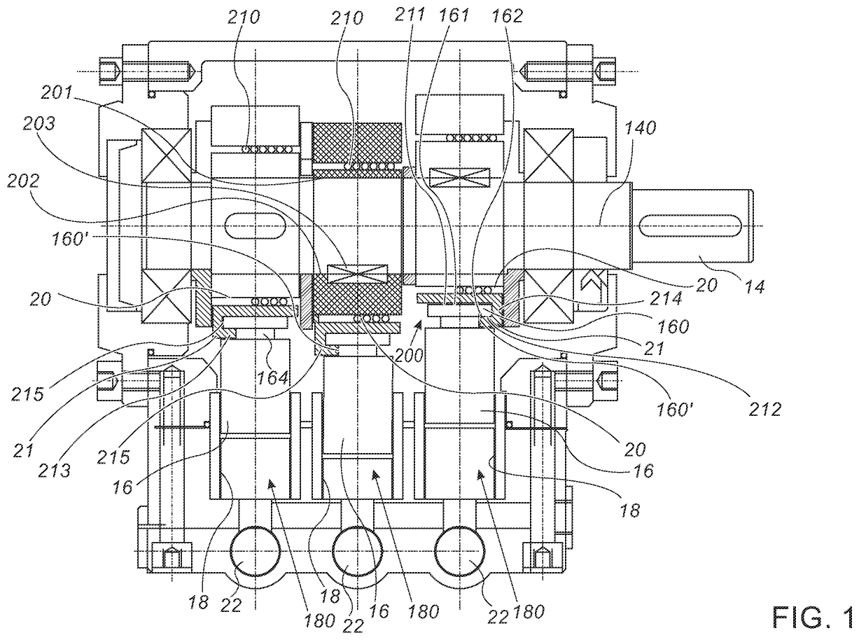

Illustrated in the attached FIG. 1 is preferred embodiment 10 of a pump which is suitable to exert a compression action on a corresponding fluid, in particular on a liquid, especially said liquid being in the form of water or hydraulic oil.

As observable from said FIG. 1, the pump 10 comprises a casing 12 for supporting a corresponding rotary shaft 14, having a respective rotation axis 140, of corresponding means for actuating said fluid, which are in the form of corresponding means 16 which are reciprocatingly movable in a respective axial direction, in particular perpendicular to or transversal to said rotation axis 140 of said shaft 14.

In particular, said means for actuating the fluid 16 are movable between a position which is retracted or approached to said rotation axis 140, and a position which is extended or moved away from the rotation axis 140.

In particular, as shown, said fluid actuating means comprise at least one respective piston 16, which is reciprocatingly moveable according to said axial direction, i.e. according to said direction transversal or perpendicular to the rotation axis 140.

In particular, as observable in FIG. 1, said fluid actuation means advantageously comprise a plurality of reciprocatingly movable actuation pistons 16, in particular three actuation pistons, in particular in a mutually temporally offset manner, and especially in a mutually uniformly offset manner as better observable hereinafter in the present description.

As shown in said FIG. 1, also provided for are corresponding means for the operative connection between said rotary shaft 14 and said fluid actuation means, or respective piston 16.

In particular, as observable from FIG. 1, the respective piston 16 for actuating the fluid is axially movable in a corresponding seat 18, in particular defined in said casing 12 and/or especially directed transversely or perpendicularly to said axis of rotation 140 of said shaft 14.

As observable, the respective seat 18 defines, on the side of the piston 16 which is opposite to the one facing toward said operative connection means 20, 21, a corresponding fluid working chamber 180, inside which said fluid is reciprocatingly compressed and conveyed toward a respective use and then suctioned, in view of a subsequent compression, by the actuation piston 16.

As illustrated, said operative connection means advantageously comprise respective driving means which comprise at least one circumferential surface 20, which is eccentrically extended with respect to said rotation axis 140 and which is rotatable together, in particular being integrally joined, with the rotary shaft 14, and means for transmitting the driving motion of said eccentric surface 20 to said fluid actuation means, or respective piston, which comprise a respective body 21 which is suitable to convert the rotary motion of said eccentric driving surface 20 into said reciprocating axial motion for said fluid actuation means, or respective piston 16.

In particular, as observable from FIG. 1, provided for in said casing 12 are a plurality of seats 18, in particular three seats, for slidably housing corresponding fluid actuation pistons 16.

In particular, as illustrated, said seats 18 are directed transversely or perpendicularly to said rotation axis 140 of said shaft 14.

In particular, as illustrated, said seats 18 extend according to directions parallel to each other.

Ad observable from FIG. 1, said operative connection means advantageously comprise a plurality of eccentric driving surfaces, in particular three eccentric driving surfaces 20, which are mutually angularly offset, in particular mutually angularly offset by 120°, and a plurality of corresponding transmission bodies, in particular three transmission bodies, 21, each respectively associated, or cooperating, with a respective eccentric driving surface 20.

As observable from FIG. 1, the respective transmission body 21 is advantageously in the form of a hollow body, circumferentially extending about the respective eccentric driving surface 20, and within which transmission body 21 the corresponding eccentric surface 20 is rotatable in rotation, in particular with the interposition of respective rolling means 210, preferably in the form of respective balls, as illustrated in particular in FIG. 1, or in the form of rollers, not particularly illustrated in the attached figures, so as to impart to said hollow transmission body 21 a reciprocating axial motion according to said axial direction transversal or perpendicular to said rotation axis 140 of the shaft 14.

As observable from FIG. 1, the respective hollow transmission body 21 has an inner surface 211 for the outer peripheral engagement of said rolling means 210 slidable on the respective eccentric driving surface 20.

Advantageously, as observable from FIG. 1, the respective eccentric driving surface 20 is defined by a corresponding body 201 having an inner opening 202, with respect to which said outer driving surface 20 extends eccentrically, and the body 201 being inserted into said rotary shaft 14.

Said eccentric body 201 is associated, in particular, as illustrated, through a corresponding key 203, with said rotary shaft 14.

As observable from FIG. 1, the plurality of operative connection units, i.e. the respective eccentric surfaces 20 and the corresponding transmission bodies 21, are advantageously positioned on the rotary shaft 14 arranged adjacent to each other.

As observable from FIG. 1 the respective transmission body 21 has a thrust surface 211 which compresses the respective piston 16 which is in particular outer, and which defines a resting surface for a respective opposite, in particular outermost, surface 161 of said actuation means, or respective piston 16, and a return surface (212), in particular opposite said thrust surface 211, which is suitable to engage, or which engages, an opposite surface 162 of the actuation means, or respective piston 16.

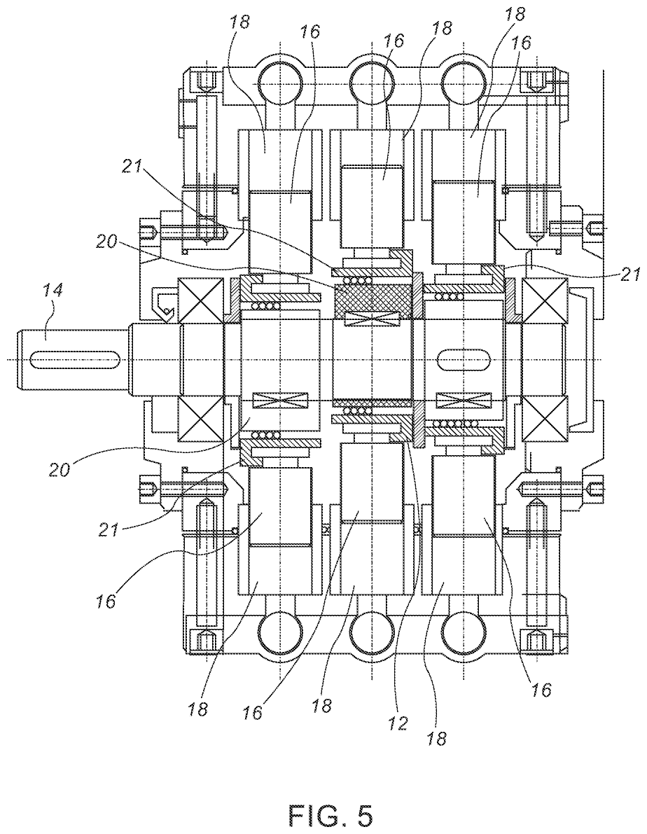

With a further advantage, according to a second preferred embodiment of the pump, illustrated in the subsequent FIG. 5, in which the components which are similar or equivalent to the ones of the first preferred embodiment are designated by the same reference numbers which were used in the previous preferred embodiment and, in order not to overburden the present description, they are not included in detail, it is provided that the respective operative connection unit, i.e. the respective eccentric surface 20 and the corresponding transmission body 21, be suitable to actuate respective first and second fluid actuation pistons 16, 16, the first and second actuating pistons 16, 16 being mutually aligned and/or being reciprocatingly movable according to the axial direction, i.e. transversal or perpendicular to the rotation axis 140 of the shaft 14, driven in corresponding and opposite seats 18, 18 provided in said casing 12 of the pump 10.

In this second preferred embodiment, the corresponding first and second pistons 16, 16 are actuated by the corresponding single transmission body 21 to which they are connected, in thrust and return action, on mutually opposite transversal or perpendicular sides.

In particular, in this second preferred embodiment, the first piston 16 has respective phases for the compression and return thrust of the fluid which are reciprocating with the ones of the corresponding second piston 16.

As observable from FIG. 1, the respective actuation piston 16 is advantageously in the form of an elongated, preferably cylindrical, body having an outermost portion 160, for the engagement by said actuation means 21, which has a corresponding plate-like configuration, which is suitable to be bidirectionally retained, according to said axial direction, in a corresponding housing 200, in particular laterally open, of the respective transmission body 21.

As observable from FIG. 1, the housing 200 for the plate-like portion 160 of the actuation piston 16 is advantageously defined by an enlarged surface 162 of the transmission body 21, which defines the resting and thrust surface for the innermost, or outermost, transversal surface 211 of said plate-like portion 160 and by an opposite surface 212 defining the engagement and return surface for an opposite face 162, which faces, in use, toward the working chamber 180, of the plate-like portion 160.

As observable, in use, said plate portion 160 of the actuation piston 16 is advantageously free to slide, in particular tangentially with respect to the circumferential direction of rotation, between said opposite resting and thrust surfaces 211 and return surface 212.

As observable from FIG. 1, said engagement and return surface 212 is advantageously defined by a transverse portion 213 of said transmission body 21 which is narrower, or shorter, with respect to the overall width of the transmission body 21 and/or the resting and thrust surface 211 thereof.

Said narrow transverse portion 213 is connected to the main part of the transmission body 21 through a corresponding short perpendicular portion 214 defining a bottom face 215 of said housing 200.

In particular, as observable from FIG. 1, said plate-like portion 160 of the actuation piston 16 is connected to the main part of the piston through a shank-like perpendicular portion 164, having a smaller diameter with respect to the diameter of the piston 16.

As observable from FIG. 1, the lateral part of said plate-like, in particular outermost, portion 160 of the actuation piston 16 for the insertion, into the housing 200 of the transmission means, or body 21, advantageously ends with a flat, or linear, edge 160′ which allows the insertion of a tangentially more extended portion of the plate 160 into the housing 200 of the transmission body 21.

Furthermore, as observable from FIG. 1, the respective working chamber 180 of the corresponding piston 16 is placed in communication with a respective conduit 22 provided for in the body of the casing 12 and in connection with means for supplying the fluid into said working chamber 180 and with use means of said fluid flowing out from the working chamber 180.

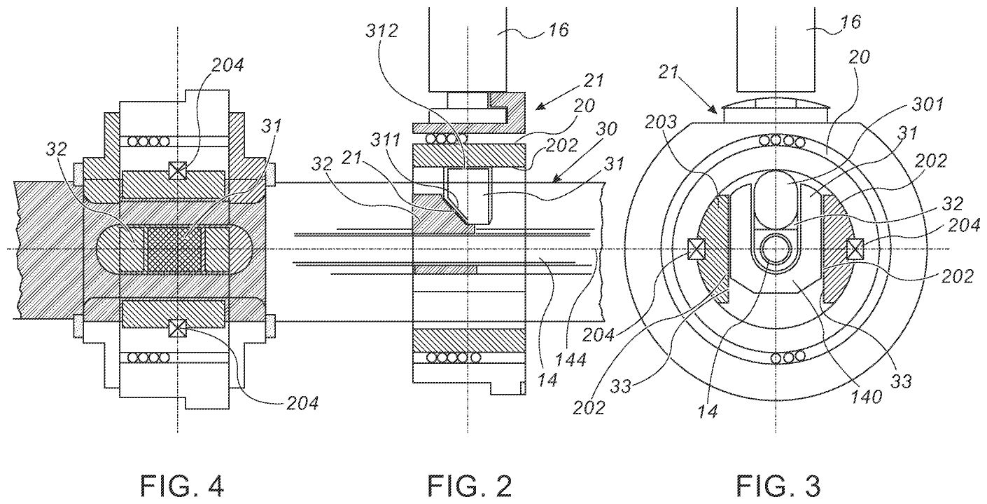

Advantageously, as observable from FIGS. 2 to 4, according to a different embodiment of the pump, it is provided that the pump comprises means 30 which are suitable to change the stroke width of the piston 16 in the respective fluid working chamber 180.

In this manner, it is possible to change the pump flow rate easily and at will, without varying the rotation speed of the respective drive shaft 14, i.e. without excessively changing the structural configuration of the pump.

As observable from said FIGS. 2 to 4, said means which are suitable to change the stroke width of the piston 16 in the respective fluid working chamber 80 advantageously comprise means 30 which are suitable to change the eccentricity of said eccentric driving surface 20 with respect to said rotation axis of said shaft 14.

As observable from FIGS. 2 to 4, said means 30 which are suitable to change the eccentricity of said eccentric driving surface 20 with respect to said rotation axis of said shaft 14 advantageously comprise an element 31 for the displacement of said eccentric surface 20 with respect to said rotation axis 140, the displacement element 31 being longitudinally movable, i.e., in the direction of the rotation axis 140, and it has a respective conical surface 311 which cooperates with a conical surface 321 which is integrally joined to said rotary shaft 14, in particular which is defined by a block 32 integrally joined to the shaft 14, so as to radially engage and displace the body 201 defining said eccentric driving surface 20 and the transmission body 21 cooperating therewith.

In particular, as observable from FIGS. 2 to 4, said body 201 defining said eccentric driving surface 20 is integrally joined in rotation with said rotary shaft 14 and it is translatable with respect thereto according to the radial extension direction of the eccentricity.

As observable from FIGS. 2 to 4, said body 201 defining said eccentric driving surface 20 is advantageously integrally joined in rotation with said rotary shaft 14 and it is translatable with respect thereto according to the radial extension direction of the eccentricity.

As observable from FIGS. 2 to 4, said element 31 for the displacement of said eccentric driving surface 20 has an outermost edge 312 which is suitable to engage the inner surface 202 of the body 201 defining said eccentric driving surface 20.

In particular, as observable from FIGS. 2 to 4, the block 32, defining said conical surface 321 and being integrally joined to said rotary shaft 14, has engaging and sliding means 33, 33, according to the radial extension direction of the eccentricity, for said body 201 defining said eccentric driving surface 20.

As observable from FIGS. 2 to 4, the block 32, defining said conical surface 321 and being integrally joined to said rotary shaft 14, preferably has opposite sliding surfaces 33, 33, according to the radial extension direction of the eccentricity, which are integrally joined, in particular through keys 204, to said body 201 defining said eccentric driving surface 20.

In order to longitudinally move said displacement element 31, with the respective conical surface 311 which cooperates with the longitudinally fixed conical surface 321, advantageously used can be an adjustment screw, or rod (not illustrated in the attached figures), which is suitable to longitudinally push against the element 31, in contrast to corresponding spring or elastic longitudinal thrust means (also not illustrated in the attached figures) against the displacement element 31 and preferably operating on the side thereof that is opposite the one engaging said adjustment screw, or rod.

As clear, the above technical characteristics illustrated above basically allow, individually or in respective combination, to achieve one or more of the following advantageous results:
providing axial pumps that are small in size, in particular so as to make them easily usable in certain situations of use, where small dimensions and/or weight are desired;
having a pump that is robust and resistant to breakage and to wear;
having a pump which is structurally simple and cost-effective;
having a pump which allows to adjustably change the stroke of the respective piston, i.e. without requiring demanding structural changes;
have a motor that is particularly versatile and/or flexible in use.

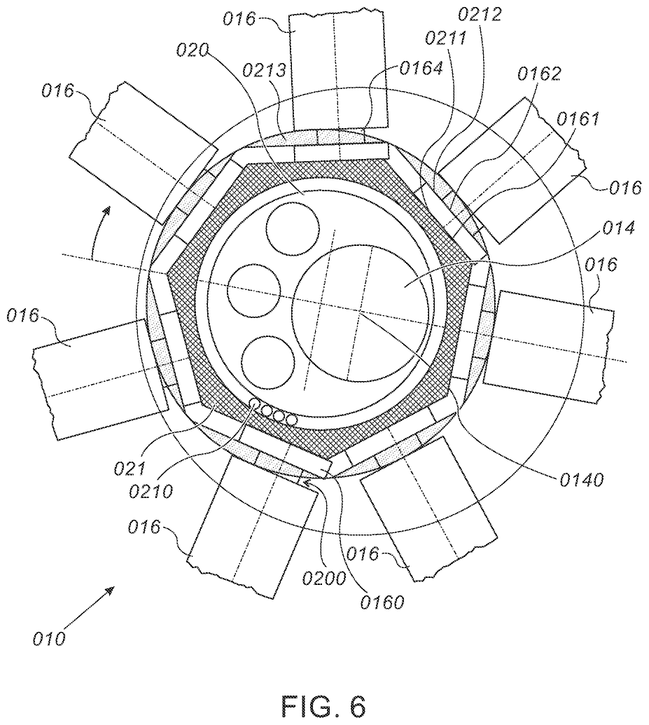

The attached FIGS. 6 to 12 illustrate a first preferred embodiment 010 of the motor, actuated by a corresponding propulsion fluid, in particular in the form of pressurized hydraulic oil.

However, it should be observed that the propulsion fluid could also be in the form of a fuel fluid generating, through a corresponding explosion, a corresponding expansion force.

Basically, besides being suitable to be actuated by a corresponding pressurized fluid, in particular in the form of hydraulic oil, the present general motor configuration is also substantially suitable to be in the form of an engine of the internal combustion type, it is only a matter of suitably changing the working chamber of the propulsion fluid and the means for introducing the fluid into said chamber, same case applying to the means for discharging the exhaust gas from the chamber.

As observable from FIGS. 6 to 12, the motor comprises a casing 012 for the rotatable support of a corresponding drive shaft 014 having a respective rotation axis 0140, and means for driving said drive shaft 014 in rotation upon a thrust of said propulsion fluid.

As observable from FIGS. 6 a 12, said means said actuation means comprise thrust means 16 reciprocatingly movable between a position which is retracted or approached to said rotation axis 0140, and a position which is extended or moved away from the rotation axis 0140.

In particular, said thrust means comprise at least one respective piston 016 which is reciprocatingly movable between said respectively extended and retracted first and second positions.

Further provided for are corresponding means for transforming the motion of said thrust means, or respective piston into a rotary motion of said drive shaft 014.

Advantageously, as shown, said transformation means comprise a respective translating body 021 movable according to the respective direction of motion of said thrust means, or respective piston 016, and a circumferential surface 020, which is eccentrically extended with respect to said rotation axis 0140 and integrally joined in rotation with the drive shaft 014, with said eccentric circumferential surface 020 which is driven into rotation by the corresponding movement of said translating body 021 so as to drive the drive shaft 014 in rotation.

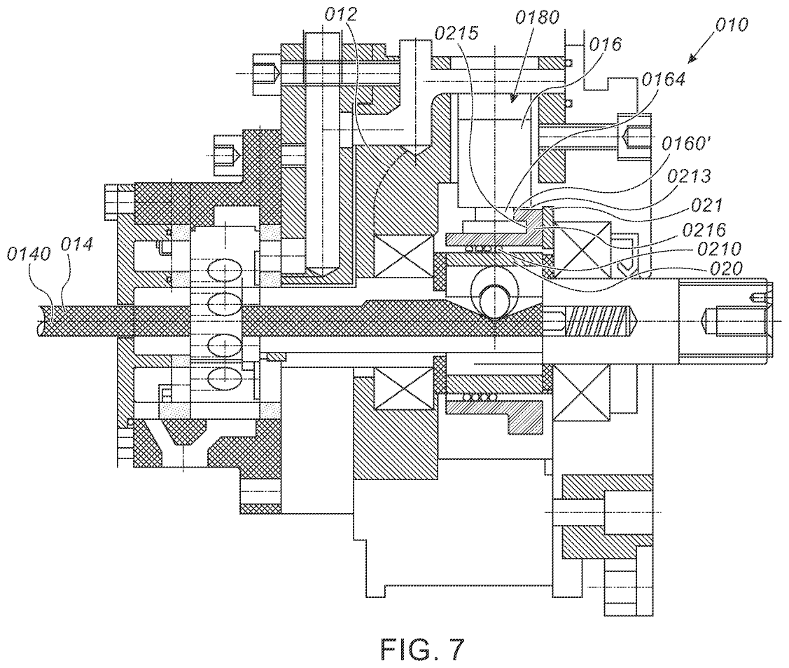

Advantageously, as observable from FIGS. 6 and 7, said thrust means, or respective piston 016 are reciprocatingly movable according to a direction radial to the rotation axis 0140 of said drive shaft 014.

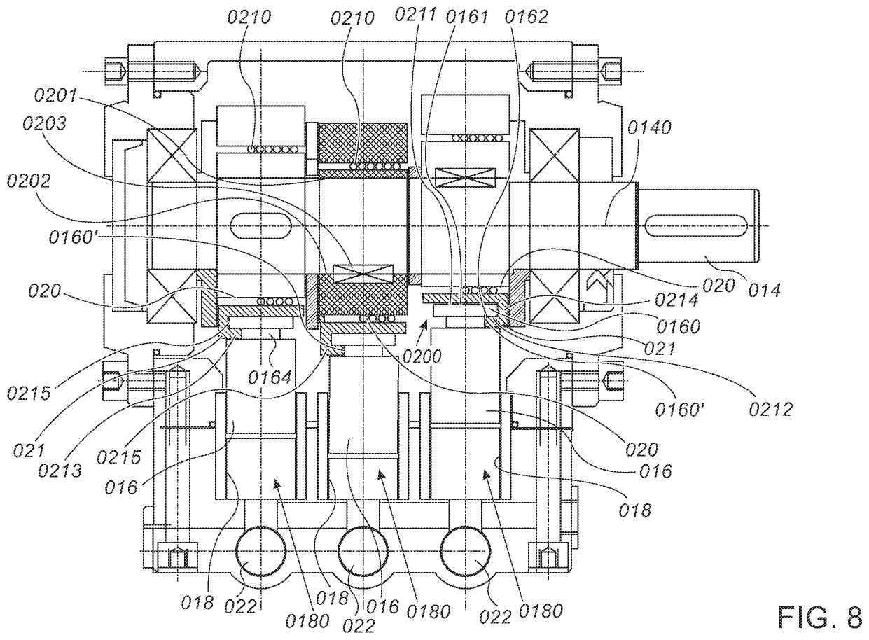

Advantageously, FIG. 8, illustrates a second preferred embodiment of the apparatus according to the present invention.

In this second preferred embodiment, the components which are similar or equivalent to those of the first preferred embodiment are marked with the same reference numbers which were used in the previous preferred embodiment and they are not commented on again in detail so as not to overburden the present description.

According to the second preferred embodiment of the motor, it is provided for that said thrust means, or respective piston 016 be reciprocatingly movable according to a respective axial direction, in particular perpendicular or transversal to the rotation axis 0140 of said drive shaft 014.

Advantageously, as observable from FIGS. 6 to 12, according to the first and second preferred embodiments of the motor, said thrust means comprise a plurality of thrust pistons 016, for example three thrust pistons as illustrated, which are movable or actuated reciprocatingly, in particular in a mutually temporally offset manner, and especially in a mutually uniformly offset manner.

Advantageously, as observable in particular from FIGS. 6 and 7, according to the first preferred embodiment, said transformation means comprise a single eccentric rotation surface 020 and a respective single translating body 021 which is suitable to move, i.e., to rotate, said eccentric rotation surface 020.

Advantageously, as observable in particular from FIG. 8, according to the second preferred embodiment, said transformation means comprise a plurality of eccentric rotation surfaces, in particular three eccentric rotation surfaces 020, which are mutually angularly offset, in particular mutually angularly offset by 120°, and a plurality of corresponding translating bodies, in particular three translating bodies 021) each being respectively associated to a respective eccentric rotation surface 020.

Advantageously, as observable from FIGS. 6 to 12, the respective translating body 021 is in the form of a hollow body, circumferentially extending about the respective eccentric rotation surface 020, and within which translating body 021 the corresponding eccentric surface 020 is rotatable in rotation, in particular with the interposition of respective rolling means 0210, preferably in the form of respective balls or rollers, so that the respective movement of said hollow translating body 021 according to the respective direction radial to said rotation axis 0140 for the rotation of the shaft 014 or axial, according to the first preferred embodiment, i.e., according to a direction transversal or perpendicular to said rotation axis (0140) of the shaft (014), according to the second preferred embodiment, is such to impart a rotatory motion to said eccentric surface 020 and to the drive shaft 014.

Advantageously, as observable from said FIGS. 6 to 12, the respective hollow translating body 021 has an inner surface 0211 for the outer peripheral engagement of said rolling means 0210 slidable on the respective eccentric rotation surface 020.

Advantageously, as observable from said FIGS. 6 to 12, the respective eccentric rotation surface 020 is defined by a corresponding body 0201 having an inner opening 0202, with respect to which said outer rotation surface 020 eccentrically extends, and which is inserted into said rotary shaft 014, said eccentric body 0201 being associated, in particular through a corresponding key 0203, to said rotary shaft 014.

Advantageously, as observable in particular from FIG. 8, according to the first preferred embodiment, the single translating body 021 is associated to, in particular it supports, and it is moved, according to a plurality of radial directions, by a corresponding plurality of thrust means, or pistons 016, which are positioned angularly spaced apart, in particular equally spaced from each other, for example, as observable from FIGS. 6 and 7, in the form of three thrust means, or pistons 016, which are positioned angularly spaced from each other by 120°.

Advantageously, as observable from FIGS. 6 and 7, according to the second preferred embodiment, the transformation units, i.e. the respective eccentric surfaces 020 and the corresponding translating bodies 021, are advantageously positioned on the rotary shaft 014 arranged adjacent to each other.

Advantageously, as observable from FIGS. 6 to 12 the respective thrust piston 016 is axially movable in a corresponding seat 018, in particular defined in said casing 012 and/or especially radially, i.e., directed transversally or perpendicularly to said rotation axis 0140 of said shaft 014; the seat 018 defining, on the side of the respective piston 016 which is opposite the one facing said transformation means 020, 021, a corresponding fluid working chamber 0180.

Advantageously, as observable from FIGS. 6 and 7, according to the first preferred embodiment, provided for in said casing 012 are a plurality of slidable housing seats 018 for corresponding thrust pistons 016, in particular directed radially to said rotation axis 0140 of said shaft 014, and/or, in particular, mutually extending angularly spaced apart or equally spaced from each other. In particular, as observable from FIGS. 6 and 7, provided for are three slidable housing seats 018 for corresponding pistons 016, which are angularly spaced from each other by 180°.

Advantageously, as observable from FIGS. 6 and 7, according to the second preferred embodiment, provided for in said casing 012 are a plurality of slidable housing seats 018 for corresponding thrust pistons 016, in particular directed transversally or perpendicularly to said rotation axis 0140 of said shaft 014, and/or, in particular, extending according to directions parallel to each other.

Advantageously, observable from FIGS. 6 to 12 the respective translating body 021 has a thrust surface 0211 which compresses the respective piston 016 which is in particular outer, and which defines a resting surface for a respective opposite, in particular outermost, surface 0161 of said thrust means, or respective piston 016, and a return surface 0212, in particular opposite said thrust surface 0211, which is suitable to engage, or which engages, an opposite surface 0162 of the thrust means, or respective piston 016.

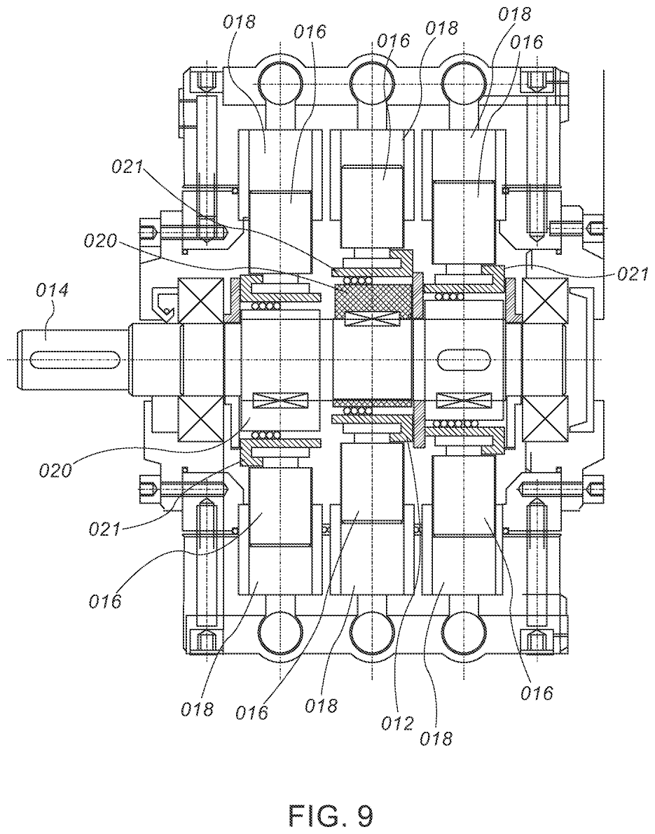

Advantageously, as observable in particular from FIG. 9, according to a second version of the second preferred embodiment of the motor, the respective transformation unit, i.e., the respective eccentric surface 020 and the corresponding translating body 021, is actuated by respective first and second thrust pistons 016, 016, the first and second thrust pistons 016, 016 being aligned with respect to each other and/or reciprocatingly movable according to the axial direction, i.e., according to the direction transversal or perpendicular to the rotation axis 0140 of the shaft 0014, driven in corresponding and opposite seats 018, 018, provided for in said casing 012 of the motor 010, said first and second pistons 016 actuating a corresponding common translating body 021 to which they are connected, in a thrust and return action, on transversal, or perpendicular sides, opposite to each other.

Advantageously, as observable from said FIGS. 6 to 12, the respective thrust piston 016 is in the form of an elongated, preferably cylindrical body, having an outermost portion 0160, for engagement by said actuation means 021, which has a corresponding plate-like shape, which is suitable to be held bidirectionally, according to said axial direction, in a corresponding housing 0200, in particular laterally open, of the respective translating body 021.

Advantageously, as observable from FIGS. 6 to 12, the housing 0200 for the plate-like portion 0160 of the thrust piston 016 is defined by an enlarged surface 0162 of the translating body 021, which defines the resting and thrust surface for the innermost, or outermost, transversal surface 0211 of said plate-like portion 0160 and by an opposite surface 0212 defining the engagement and return surface for an opposite face 0162, which faces, in use, toward the fluid working chamber 0180, of the plate-like portion 0160.

Advantageously, as observable from said FIGS. 6 to 12, said engagement and return surface 0212 is defined by a transversal portion 0213 of said translating body 021 which is narrower, or shorter, with respect to the overall width of the translating body 021 and/or the resting and thrust surface 0211 thereof, said narrower transversal portion 0213 being connected to the main part of the translating body 021 through a corresponding short perpendicular portion 214 defining a bottom face 0215 of said housing 0200.

Advantageously, as observable from said FIGS. 6 to 12, said plate-like portion 0160 of the thrust piston 016 is connected to the main part of the piston through a shank-like perpendicular portion 0164, having a smaller diameter with respect to the diameter of the piston 016.

Advantageously, as observable from said FIGS. 6 to 12, the lateral part of said plate-like, in particular outermost, portion 0160 of the thrust piston 016 for the insertion, into the housing 0200 of the means, or translating body 021, ends with a flat, or linear, edge 0160′ which allows the insertion of a tangentially more extended portion of the plate 0160 into the housing 0200 of the translating body 021.

Advantageously, as observable from said FIGS. 6 to 12, the respective fluid working chamber 0180, is placed in communication with a respective conduit 022 provided for in the body of the casing 012 and in connection with means for supplying the fluid into said fluid working chamber 0180 and with use means of said fluid flowing out from the fluid working chamber 0180.

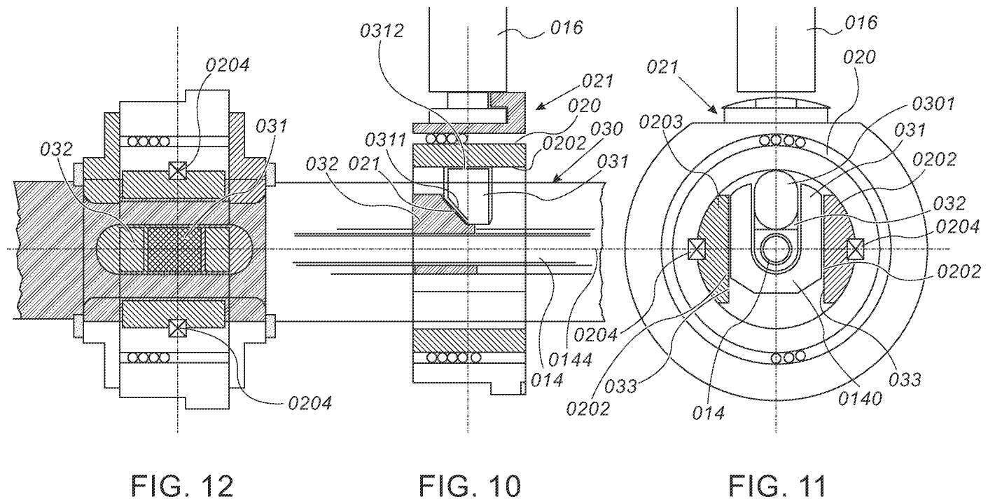

Advantageously, as observable from FIGS. 10 to 12, provided for are means 030 which are suitable to change the stroke width of the piston 016 in the respective fluid working chamber 0180.

Advantageously, as observable from FIGS. 10 to 12, said means which are suitable to change the stroke width of the piston 016 in the respective fluid working chamber 0180 comprise means 030 which are suitable to change the eccentricity of said eccentric rotation surface 020 with respect to said rotation axis of said shaft 014.

Advantageously, as observable from FIGS. 10 to 12, said means 030 which are suitable to change the eccentricity of said eccentric rotation surface 020 with respect to said rotation axis of said shaft 014 comprise an element 031 for the displacement of said eccentric surface 020 with respect to said rotation axis 0140, the displacement element 031 being longitudinally movable, i.e., in the direction of the rotation axis 0140, and it has a respective conical surface 0311 which cooperates with a conical surface 0321 which is integrally joined to said rotary shaft 014, in particular, which is defined by a block 032 integrally joined to the shaft 014, so as to radially engage and displace the body 0201 defining said eccentric rotation surface 020 and the translating body 021 cooperating therewith.

Advantageously, as observable from FIGS. 10 to 12, said body 0201 defining said eccentric rotation surface 020 is integrally joined in rotation with said rotary shaft 014 and it is translatable with respect thereto according to the radial extension direction of the eccentricity.

Advantageously, as observable from FIGS. 10 to 12, said element 031 for the displacement of said eccentric rotation surface 020 has an outermost edge 0312 which is suitable to engage the inner surface 0202 of the body 0201 defining said eccentric rotation surface 020.

Advantageously, as observable from FIGS. 10 to 12, the block 032, defining said conical surface 0321 and being integrally joined to said rotary shaft 014, has engaging and sliding means 033, 033, according to the radial extension direction of the eccentricity, for said body 0201 defining said eccentric rotation surface 020.

Advantageously, as observable from FIGS. 10 to 12, the block 032, defining said conical surface 0321 and being integrally joined to said rotary shaft 014, has opposite surfaces 033, 033, sliding according to the radial extension direction of the eccentricity, for opposite surfaces 0202, 0202 of corresponding and opposite portions 0203, which are integrally joined to said body 0201 defining said eccentric rotation surface 020.

In order to longitudinally move said displacement element 031, with the respective conical surface 031 which cooperates with the longitudinally fixed conical surface 0321, provided for is an adjustment screw, or rod, which is suitable to longitudinally push against the element 031, in contrast to corresponding spring or elastic longitudinal thrust means against the displacement element 031 and preferably operating on the side thereof that is opposite the one engaging said adjustment screw, or rod.

Advantageously, as observable, in use, said plate portion 0160 of the thrust piston 016 is free to slide, in particular tangentially with respect to the circumferential direction of rotation, between said opposite resting and thrust surfaces 0211 and return surface 0212.

As clear, the above technical characteristics illustrated above basically allow, individually or in respective combination, to achieve one or more of the following advantageous results:
providing motors that are small in size, in particular so as to make them easily usable in certain situations of use, where small dimensions and/or weight are desired;
having a motor that is robust and resistant to breakage and wear.

1-56. (canceled)

57. A pump suitable to exert a compression action on a fluid, in particular on a liquid, especially said liquid being in the form of water or hydraulic oil; the pump comprising a casing for the rotatable support of a corresponding shaft having a respective rotation axis, means for the actuation of said fluid which are in the form of means reciprocatingly movable according to a respective axial direction, in particular perpendicular or transversal to the rotation axis of said shaft, between a position which is retracted or approached to said rotation axis, and a position which is extended or moved away from the rotation axis; said fluid actuation means comprising at least one respective piston which is reciprocatingly moveable according to said axial direction; and provided for being corresponding means for the operative connection between said rotary shaft and said fluid actuation means, or respective piston,; wherein said operative connection means comprise respective driving means, which comprise at least one circumferential surface which is eccentrically extended with respect to said rotation axis and which is rotatable together, in particular being integrally joined, with the rotary shaft, and motion transmission means for the driving of said eccentric surface to said fluid actuation means, or respective piston, the transmission means comprising a respective body which is suitable to convert the rotary motion of said eccentric driving surface into said reciprocating axial motion for said fluid actuation means, or respective piston.

58. The pump according to claim 57, wherein said fluid actuation means comprise a plurality of reciprocatingly movable actuation pistons, in particular three actuation pistons, in particular in a mutually temporally offset manner, and especially in a mutually uniformly offset manner.

59. The pump according to claim 58, wherein said operative connection means comprise a plurality of eccentric driving surfaces, in particular three eccentric driving surfaces, which are mutually angularly offset, in particular mutually angularly offset by 120°, and a plurality of corresponding transmission bodies, in particular three transmission bodies, each being respectively associated to a respective eccentric driving surface.

60. The pump according to claim 57, wherein the respective transmission body is in the form of a hollow body, circumferentially extending about the respective eccentric driving surface, and within which transmission body the corresponding eccentric surface is rotatable in rotation, in particular with the interposition of respective rolling means, preferably in the form of respective balls or rollers, so as to impart to said hollow transmission body a reciprocating axial motion according to said axial direction transversal or perpendicular to said rotation axis of the shaft.

61. The pump according to claim 60, wherein the respective hollow transmission body has an inner surface for the outer peripheral engagement of said rolling means slidable on the respective eccentric driving surface.

62. The pump according to claim 57, wherein the respective eccentric driving surface is defined by a corresponding body having an inner opening, with respect to which said outer driving surface extends eccentrically, and which is inserted on said rotary shaft, said eccentric body being associated, in particular through a corresponding key, to said rotary shaft.

63. The pump according to claim 57, wherein the operative connection units, i.e., the respective eccentric surfaces and the corresponding transmission bodies, are positioned on the rotary shaft adjacent to each other.

64. The pump according to claim 57, wherein the respective fluid actuation piston is axially movable in a corresponding seat, in particular defined in said casing and/or especially transversally or perpendicularly directed to said rotation axis of said shaft; the seat defining, on the side of the respective piston which is opposite the one facing said operative connection means, a corresponding fluid working chamber, within which said fluid is reciprocatingly compressed and conveyed towards a respective use and suctioned, in view of a subsequent compression, by the actuation piston.

65. The pump according to claim 64, wherein, provided for in said casing, is a plurality of slidable housing seats, in particular three seats, for corresponding fluid actuation pistons, in particular transversally or perpendicularly directed to said rotation axis of said shaft, and/or, in particular, extending according to directions parallel to each other.

66. The pump according to claim 57, wherein the respective transmission body has a thrust surface which compresses the respective piston, which is in particular outer, and which defines a resting surface for a respective opposite, in particular outermost, surface of said actuation means, or respective piston, and a return surface, in particular opposite said thrust surface, which is suitable to engage, or which engages, an opposite surface of the actuation means, or respective piston.

67. The pump according to claim 57, wherein the respective operative connection unit, i.e., the respective eccentric surface and the corresponding transmission body, is suitable to actuate respective first and second fluid actuation pistons, the first and second actuation pistons being aligned with one another and/or reciprocatingly movable according to the same axial direction, i.e., transversal or perpendicular to the rotation axis of the shaft, driven in corresponding and opposite seats, provided for in said casing of the pump, said first and second pistons being actuated by the corresponding single transmission body to which they are connected, in a thrust and return action, on transversal or perpendicular sides, opposite to each other.

68. The pump according to claim 57, wherein the respective actuation piston is in the form of an elongated, preferably cylindrical, body having an outermost portion, for the engagement by said actuation means, which has a corresponding plate-like configuration, which is suitable to be bidirectionally retained, according to said axial direction, in a corresponding housing, in particular laterally open, of the respective transmission body.

69. The pump according to claim 68, wherein the housing for the plate-like portion of the actuation piston is defined by an enlarged surface of the transmission body, which defines the resting and thrust surface for the innermost, or outermost, transversal surface of said plate-like portion and by an opposite surface defining the engagement and return surface for an opposite face, which faces, in use, toward the working chamber, of the plate-like portion.

70. The pump according to claim 69, wherein said engagement and return surface is defined by a transversal portion of said transmission body which is narrower, or shorter, with respect to the overall width of the transmission body and/or the resting and thrust surface thereof, said narrower transversal portion being connected to the main part of the transmission body through a corresponding short perpendicular portion defining a bottom face of said housing.

71. The pump according to claim 68, wherein said plate-like portion of the actuation piston is connected to the main part of the piston through a shank-like perpendicular portion, having a smaller diameter with respect to the diameter of the piston.

72. The pump according to claim 68, wherein the lateral part of said plate-like, in particular outermost, portion of the actuation piston for the insertion, into the housing of the transmission means, or body, ends with a flat, or linear, edge which allows the insertion of a tangentially more extended portion of the plate into the housing of the transmission body.

73. The pump according to claim 68, wherein the respective working chamber of the corresponding piston is placed in communication with a respective conduit provided for in the body of the casing and in connection with means for supplying the fluid into said working chamber and with use means of said fluid flowing out from the working chamber.

74. The pump according to claim 68, wherein provided for are means which are suitable to change the stroke width of the piston in the respective fluid working chamber.

75. The pump according to claim 74, wherein said means which are suitable to change the stroke width of the piston in the respective fluid working chamber comprise means which are suitable to change the eccentricity of said eccentric driving surface with respect to said rotation axis of said shaft.

76. The pump according to claim 75, wherein said means which are suitable to change the eccentricity of said eccentric driving surface with respect to said rotation axis of said shaft comprise an element for the displacement of said eccentric surface with respect to said rotation axis, the displacement element being longitudinally movable, i.e., in the direction of the rotation axis, and it has a respective conical surface which cooperates with a conical surface which is integrally joined to said rotary shaft, in particular which is defined by a block integrally joined to the shaft, so as to radially engage and displace the body defining said eccentric driving surface and the transmission body cooperating therewith.
